(19) United States
(12) Patent Application Publication
(10) Pub. No.: US 2007/0081696 A1
(43) Pub. Date: Apr. 12, 2007

(54) Biometric control for kitchen appliance

(75) Inventors: Steve Brennan, Farmington, CT (US); William Flynn, Naugatuck, CT (US); George F. Koether, Southport, CT (US); Ed Musial, Milford, CT (US)

Correspondence Address: EDWARDS & ANGELL, LLP, P.O. BOX 55874, BOSTON, MA, 02205, US

(73) Assignee: Technology Licensing Corporation, Fort Lauderdale, FL (US)

(21) Appl. No.: 11/233,299

(22) Filed: Sep. 22, 2005

(51) Int. Cl. G06K 9/00

(52) U.S. Cl. 382/115; 340/5.52

(57) ABSTRACT

A kitchen appliance including a biometric detector for capturing biometric characteristic. A database contains user profile information including at least a biometric identity data corresponding to a biometric characteristic. A computer is operatively coupled to the biometric input device and database for controlling the operation of the kitchen appliance in response to the biometric characteristic and as a function of the user profile information.

### BACKGROUND OF THE INVENTION

This application is directed to the use of a biometric detector to control access and use of equipment, and more particularly, the use of biometric switches to control the operation of a kitchen appliance.

In food preparation facilities, such as restaurants, commercial kitchens or the like, it is often necessary to control access to the kitchen appliances contained within the facility and to certain features and functions of the various appliances utilized by the various employees. Certain equipment, such as ware washing equipment need not be accessed by those employees responsible for food preparation. Conversely, ovens, fryers, refrigerators and the like need not necessarily be accessed during operation by those responsible for cleaning the facility. Typically, access to such kitchen appliances is either left uncontrolled, or is controlled through the use of simple pass codes entered by way of touch pad or keyboard associated with the appliance. To this end, pass codes are often programmed into each apparatus to limit access to the specific kitchen appliance by those who have been entrusted with the pass code.

When employed, these pass codes are typically preprogrammed at the factory and may be the same from device to device and from facility to facility. Often the pass code is forgotten by the employee or worse is remembered long after the employee is to be denied access to the appliance. Further, the employee may intentionally or inadvertently give the pass code to others who are not entitled to operate the kitchen appliance. As a result, unauthorized or under-skilled persons are able to make use of the kitchen appliance. The circulation of the pass code, in effect, makes the need for a pass code moot.

The prior art system has been satisfactory, however, it suffers from the shortcomings that if unfettered access is allowed to the appliance, non-qualified personnel will be enabled to operate the appliance resulting in safety code violations or a degradation in operation of the appliance and a degradation in food quality. At best, food quality will be inconsistent from run to run. Additionally, if unauthorized and untrained personnel are allowed access to certain kitchen appliances, the risk of injury, such as the use of meat slicing devices or a kitchen fryer by untrained workers, can occur. Lastly, often a single kitchen appliance may require a different setup from user to user, dependent upon the task, for example, the instructions for the appliance may be in English for one user but required to be in Spanish for another. This requires additional time in setting up amongst users even when password access is provided.

Accordingly, a method and apparatus for allowing desired employees to access desired machinery which does not allow for duplication of pass codes or unintentional or unauthorized access is required.

### BRIEF SUMMARY OF THE INVENTION

A kitchen appliance includes a biometric input device for capturing a biometric characteristic. A database, containing user profile information, including at least a biometric identity data corresponding to the biometric characteristic is also associated with the kitchen appliance. A computer, operatively coupled to the biometric input device, database and kitchen appliance, controls operation of the kitchen appliance in response to the captured biometric characteristic and the profile information.

In a preferred embodiment, the profile information includes the machine-allowed functionality for the identified user and is stored with the associated biometric identity data. The computer may also include a clock for date stamping the operation of the appliance by each user and tracking the time of appliance use by each respective user. The input of the biometric data at the biometric input device controls operation of the clock.

Furthermore, a variety of profiles for each individual user may be stored with associated different biometric data. In a preferred example, biometric data may be voice recognition data, fingerprint data, retinal print data, digitized appearance data, such as a face shot or the like. Additionally, each finger has an individual fingerprint, which may be stored as profile information associated with a different respective operating profile of the kitchen appliance. By way of non-limiting example, in operating an oven, recipes for pizza corresponds to a thumb, casseroles correspond to an index finger, lasagna corresponds to the middle finger and toasting a sandwich corresponds to a pinkie finger. As a result, operation of the oven may be controlled by the finger (biometric characteristic) used to login.

During operation, the method performed by the appliance is that after initialization of the database with the user profile, including biometric identity data, and user appliance operation profiles, the user inputs biometric data at the biometric input device. The CPU compares the biometric data to biometric data stored within the database to determine whether there is a match. If a match is found, then the CPU enables the kitchen appliance in accordance with the functionality permitted to that user. In an optional, but preferred embodiment, the user, having completed the task, would “logoff” by reentering the biometric data at the input device or the user's session would “time-out”. The CPU monitors the time and frequency of use and stores that information as part of the profile information in the database.

It should be noted that, in a preferred embodiment, the CPU is a remote server capable of monitoring several kitchen appliances, but it needs to be a remote server. One biometric device and CPU can be included in each appliance.

### BRIEF DESCRIPTION OF THE DRAWINGS

For a fuller understanding of the invention, reference is had to the following description taken in connection with the accompanying drawings in which:

FIG. 1 is a schematic diagram of a kitchen appliance constructed in accordance with the invention;

FIG. 2 is a schematic representation of a database constructed in accordance with one embodiment of the invention; and

FIG. 3 is a flow chart for the operation of the kitchen appliance in accordance with the invention.

### DETAILED DESCRIPTION OF THE INVENTION

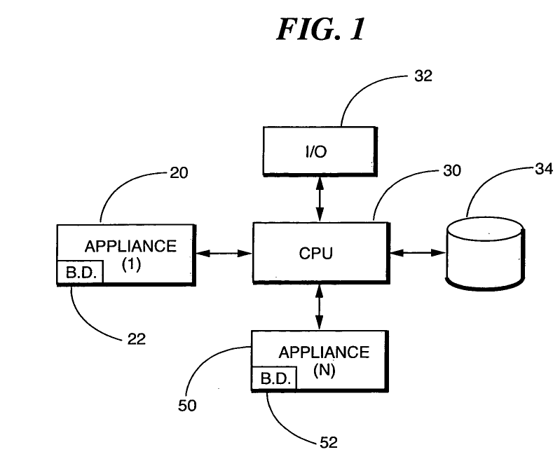

Reference is first made to FIG. 1 in which a system, generally indicated as 10, includes a first kitchen appliance 20 having a biometric detection device 22 associated therewith.

Kitchen appliance 20 is in communication with and operates under the control of a central processing unit (CPU) 30. CPU 30 includes associated input/output device 32 and database 34. CPU 30 is also operatively connected to control the operation of an Nth appliance 50 having its own associated Nth biometric detector 52 so that system 10 is capable of operating N kitchen appliances.

Kitchen appliance 20 may be any commonly known kitchen appliance by way of non-limiting example a conventional oven, a microwave oven, a combination oven (combining microwave and convection or conventional heating), a meat slicer, a fryer, a refrigerator, a rotisserie, warming station, ware washer, or the like. Each appliance 20 has an associated biometric detector 22. Biometric detector 22 may be integrally formed with the appliance or, provided as a modular add-on device. Biometric detector 22 is any device capable of capturing and recognizing a personal biological trait such as palm print, fingerprint, retinal scan, face recognition device, voice recognition device or the like capable of identifying one individual from another. The biometric characteristic captured at biometric detector 22 is then processed by CPU 30.

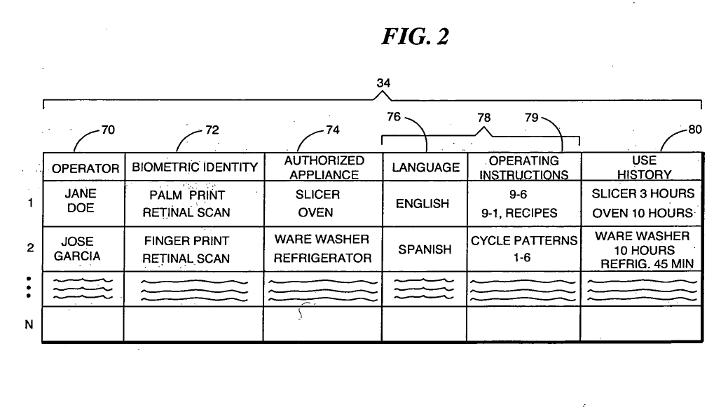

As shown in FIG. 2, database 34 stores a library of files 1 through M for all personnel potentially authorized to utilize any one or all of appliances 1 through N. At a minimum, each file contains the identity of each user/operator 70 of the appliance and their associated biometric identity data 72 such as thumbprint, palm print, retinal pattern or the like for each individual. Other profile information stored as part of the file may include, by way of non-limiting example, authorized appliances data 74 corresponding to appliances 1-N a particular user is authorized to utilize as mapped to the biometric identity data 72. Mode of operation data 78, including language mode, operating instructions, or authorization parameters and functionality, as discussed below, may also be stored in a user file.

Each user may be provided with different functionality authorizations. By way of example, appliance 20 may be refrigerator, while appliance 50 may be an oven. A first employee, when recognized by CPU 30 by comparing the biometric characteristic captured at biometric detector 22 and comparing it with the biometric identity data 72 in database 34, will control appliance 20 to allow the user to enter the refrigerator to retrieve food or perform maintenance, but not allow the user to change the settings because of the health implications. However, if the employee is responsible for preparing food, CPU 30 would control appliance 50 (an oven) to allow that same employee to change the cooking settings and temperatures as required for specific recipes.

On the other hand, CPU 30 recognizing the biometric data of the manager, would allow full functionality, including the changing of all settings for both kitchen appliances 20 and 50. In a preferred embodiment, one of the modes may even be the language in which the prompts are provided at the kitchen appliance. By way of example, kitchen appliance 50 is an oven. As is now known in the art, ovens like many appliances are provided with LCD control panels for prompting the user throughout the operation. If one employee speaks English, CPU 30 determines the language of operation by comparing biometric data input at the appliance, determines the appropriate user file, if any, and utilizing the associated language data 76, controls appliance 50 to provide the instructional prompts in English. If, on the other hand, a second user speaks another language such as Spanish or French, CPU 30 controls the display on kitchen appliance 50 to provide the prompts in that second language.

In yet another example, a plurality of distinct biometric identity data is stored. This may for example be the fingerprint from each individual finger of a user. A different set of operating instructions 79 may be mapped and stored as part of the file in database 34 corresponding to a distinct functionality. By way of non-limiting example, if appliance 50 were an oven, it is known in the art to preprogram recipes in appliance 50. For example, as is known in the art from U.S. Pat. No. 4,920,948 it is known to preprogram the sequential change in temperature and airflow for a combination oven in accordance with a recipe for cooking a single food item such as frozen pizza.

A recipe for frozen pizza is different from a recipe for a toasted sandwich, or a casserole dish. By associating the control required for the pizza at appliance 50 with a thumbprint, the control recipe for a toasted sandwich with the index finger fingerprint and the control for a casserole type dish with the middle finger fingerprint, CPU 30 automatically sets the operating instructions for appliance 50 for the appropriate use. In this way, the miscooking of food is greatly reduced and the operational steps for preparing food are reduced to a single step of allowing the biometric detector 52 to capture the appropriate biometric identity data. At the same time, not only is quality control increased by minimizing misprogramming of appliance 50 for each cook cycle, the ability to cook specific recipes is limited to authorized personnel.

By requiring a logon and logoff during each use, CPU 30 may monitor and count the number of discrete operations performed by appliances 20, 50. In this way, a manager is provided with a record of machine use and employee use, knowing when the employee is most active, and identifying unauthorized breaks by large gaps between successive logoffs and logons at the different kitchen appliances 20, 50. The logon and logoff, in some cases, may be done automatically with use of the device.

By way of example, a meat slicer utilized in commercial kitchens generally requires the maneuvering of a handle during the entire slicing process. If the biometric detector 22, by way of example, is placed on the handle of kitchen appliance 20 as a meat slicer, and the sought after biometric is a fingerprint or palm print, biometric detector 22 is continuously monitoring the presence of that biometric data. In the first instance, it can prevent the unlawful use of the meat slicer by anyone under the age of 18 (as required by many labor codes) by comparing the biometric identity data 72 to associated authorized appliances 74. CPU 30 monitors the time of actual use by each individual by determining the time between log on and log off, which may be stored as use history data 80.

In a further preferred embodiment, CPU 30 includes a counter 22, enabled to count at least the number of uses by counting logins at the operation start time, i.e., the time at which a user is recognized by the system for each specific appliances 20, 50. CPU 30 counts an elapsed time corresponding to the start time until the user logs off by again capturing the desired biometric identity data. Start time, elapsed time and stop time can be stored in database 34 as a portion of history data 80 for an individual user. In this way, a manager may monitor not only appliance use, but also the efficiency of that use by particular users as a function of time devoted to task.

In another exemplary embodiment, profiles for each appliance 20, 50 may be determined regardless of the user. By way of example, appliance 20 may be maintained within a temperature range throughout its entire run cycle if it is a refrigerator. However, the recipes utilized by appliance 50, if an oven, may change dependent upon the time of day. There are different recipes for the breakfast shift, as opposed to the lunch shift as opposed to the dinner shift in many restaurants. Furthermore, a user's profile information may include the anticipated work hours, locking them out of unauthorized after hours use. By utilizing the clock of CPU 30 and the authorized operation mode of appliance 50 stored in database 34 as mode data 78, CPU 30 can prevent the cooking of food which should be unavailable during predetermined times of day. By not giving the option to the user, there is less chance for miscooking the food by entering the wrong recipe reducing waste.

An input/output device 32 is provided to upload the data necessary for the files maintained at database 34. The input/output device 32 may be a graphical user interface, a touch screen, a keyboard, a flash card or the like, in a preferred embodiment, if not directly on appliance 20 may require a biometric detector of its own to download that portion of the file data.

It should be noted that FIG. 1 shows a system 10 as a distributed network with a single CPU 30 and database 34 being responsible for controlling the operation of N appliances 20, 50. However, it should be noted that the entire functionality of CPU 30 and database 34 may be provided at the respective appliance 20, 50 to form an integral standalone device. Alternatively, a single appliance 20 having the functionality of CPU 30 incorporated therein may act as a master appliance to the N-1 remaining appliances.

When formed as a distributed network, it should be noted that each element of the system may be combined with another element or stand independently as environmental design considerations dictate. Each element of system 10 can communicate with another by the Internet, radio frequency, telephone, cellular telephone, cable, and handheld personal data accessory by way of non-limiting example.

CPU 30 is any device capable of performing the functionality described above and below. In the distributed network system, it may be a personal computer at a control center, or a server as part of an Internet- or Intranet-based network. When incorporated integrally with the circuitry of appliance 20 and/or appliance 50, then it will form part of the internal circuitry of each appliance. It should be noted that the functionality described above may be found entirely at appliance 20, entirely at CPU 30, or distributed amongst CPU 30 and each of appliances 20,50 as a function of the processing capabilities of appliances 20,50.

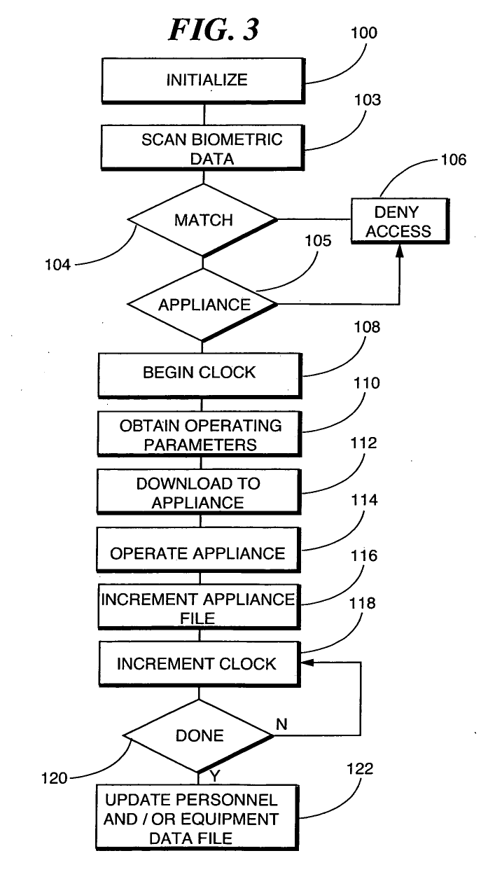

Reference is now made to FIG. 3 in which a flow chart for the operation of system 20 in accordance with the invention is provided.

As each new operator and/or kitchen appliance is added to system 10, the database is initialized with the corresponding data in a step 100. In step 100, the data files are created. By way of non-limiting example, for each appliance, the database may include as mode data 78 authorized times of use, any requirements for authorized use, a file of recipes as compared to times of day, operating instructions for a particular appliance such as recipes to be employed on that appliance, a use count and a use time. For personnel, the database file will include biometric identity data 72 corresponding to the biometric characteristic of that employee which is to be utilized, use authorizations on an appliance-by-appliance basis as data 74, customized setup parameters such as language data 76, an appliance count and time clock as history data 80. Step 100 is not necessary if both the appliance and the operator have been part of system 10 previously.

In a step 102, appliance 20 and/or 50 scans the biometric data of interest at biometric detector 22. In a step 104, CPU 30 compares the captured biometric data to the biometric data stored in database 34 to determine whether a match has occurred. If no match has occurred, then operation of appliance 20 is denied in a step 106.

If a comparison by CPU 30 of the received biometric information data and the biometric identity data 72 stored in database 34 is determined to be a match, CPU 30 determines whether that user is authorized for the specific kitchen appliance from which biometric data is received in a step 105. This check may be performed one of two ways. In one embodiment, CPU 30 compares the appliance from which the biometric data was received to the authorized appliance data 74 corresponding to the user/operator 70 as determined from step 104. If a match does not occur, then access is denied in step 106, preventing unauthorized use of a kitchen appliance even by operators who are authorized for uses of other appliances.

In another embodiment, operator characteristic data beyond biometric identity data 72, such as training level, age, use certifications, may be stored as operator data 70. CPU 30 after having identified the operator in step 104 may then compare operator data 70 to use parameters stored in the appliance file. For example, if the mode of operation or the authorization requirement of a required certification or required age for a particular device is stored in the appliance database, then CPU 30 compares that requirement to the operator data 70. If a match does not occur, then the process moves to step 106 in which access is denied.

If access is granted, then CPU 30 begins clocking elapsed time in a step 108 and may date stamp the time of use. At the same time, in a step 110, CPU determines the parameters of operation associated with the authorized user as determined from the parameters stored as language data 76 and mode data 78 associated with the identified user in database 34 in step 110. In step 112, these parameters are downloaded to appliance 20 or if CPU 30 is in fact a portion of appliance 20, CPU 30 may directly operate appliance 20 in accordance with the authorized parameters and the modes of operation stored in any appliance file.

By way of example, in step 110 if it is determined that the authorized user speaks Spanish, then CPU 30 would cause all displays at appliance 20 to be in the Spanish language for ease of use by the operator. In another not mutually exclusive embodiment, CPU 30 determines the time of day and in accordance with operating instructions and parameters 79 stored in database 34, determines which menus or operating parameters are to be made available during that time period and disables all other menus or operating options at appliance 20. By way of example, if it is determined that a lunchtime operation for an oven 20 is to be utilized, recipes for cooking breakfast foods may be disabled. In another preferred embodiment, CPU 30 would control appliance 20 so that the user could only operate the use of the menus, and not change the use of the menus by determining the level of authorizations allowed that user as stored in database 34. CPU 30 would disable the non-authorized functionality of appliance 20 or refrain from downloading unauthorized operating instructions to appliance 20.

In a step 114, the authorized user utilizes appliance 20. In a step 116, CPU 30 increments the appliance data file stored in database 34, increasing the use count for the used kitchen appliance. At the same time, the real-time clock is incremented in a step 118.

In a step 120, it is determined whether the user has completed the task required by kitchen appliance 20. This may be accomplished in one of three ways. First, the user may be required to logout utilizing biometric detector 22. Second, if the appliance is to be used in accordance with defined appliance operating instructions, the task is finished upon completion of the last instruction as determined by CPU 30. This may be appropriate, by way of non-limiting example, if appliance 20 is an oven, which has performed the entire recipe, or ware washing equipment, which has gone through each of the wash cycles. Lastly, because CPU 30 utilizes an onboard clock, inactivity of appliance 20 over a predetermined period of time may timeout the use of the appliance based upon the assumption that non-use is evidence of a completed task. If a predetermined amount of time has elapsed, then the user may be required to login again. If it is determined that the task is not completed in step 120, the process is returned to step 118 in the real-time clock. If the task is completed, the clock is stopped in a step 120 and the equipment and personnel data files are updated to reflect the time of use and amount of use of the appliance by the authorized personnel.

By providing the use of kitchen appliance under biometric data access control, not only may unauthorized use of the apparatus be prevented, but also misuse of the apparatus is prevented because the use of biometric data allows automatic customization of the apparatus. Furthermore, inefficiencies in use may be determined by tracking use by appliance and user.

It should be noted that the methodology described in connection with FIG. 3 is an exemplary methodology. However, at a minimum, steps 100, 116-122 are not required to practice the invention.

Thus, while there have been shown, described and pointed out novel features of the present invention as applied to preferred to embodiments thereof, it will be understood that the various omissions and substitutions and change in the form and detail are contemplated so that the disclosed invention may be made by those skilled in the art without departing from the spirit and scope of the invention. It is the intention therefore, to be limited only as indicated by the scope of the claims appended hereto. It is also to be understood that the following claims are intended to cover all of the generic and specific features of the invention herein described and all statements of the scope of the invention, which as a matter of language, might be said to fall therebetween.

What is claimed as new and desired to be protected by Letters Patent of the United States is:

1. A kitchen appliance comprising:
a biometric input device for capturing a biometric characteristic;
a database, containing user profile information including at least a biometric identity data corresponding to said biometric characteristic;
a computer operatively coupled to said biometric input device, and said database for controlling operation of said kitchen appliance in response to said biometric characteristic and as a function of said user profile information.

2. The kitchen appliance of claim 1, wherein said biometric input device is integrally formed with said kitchen appliance.

3. The kitchen appliance of claim 1, further comprising an input/output device for downloading said user profile information, said input/output device operatively coupled to said computer.

4. The kitchen appliance of claim 3, wherein said input/output device is a graphical user interface, a touch screen, keyboard, or flash card.

5. The kitchen appliance of claim 1, wherein said user profile information further comprises operating mode data for said kitchen appliance, said operating instructions corresponding to authorized uses of said kitchen appliance by a user corresponding to said biometric identity data.

6. The kitchen appliance of claim 5, wherein said operating mode data includes instructions for operating the kitchen appliance in a language corresponding to the user identified by the biometric data information.

7. The kitchen appliance of claim 1, further comprising kitchen appliance characteristic files stored in said database, said kitchen appliance characteristic files including operating parameters for said kitchen appliance.

8. The kitchen appliance of claim 7, wherein said kitchen appliance characteristic data includes an authorized age for potential users of said appliance,

9. The kitchen appliance of claim 8, wherein said computer determines the age of a user of said kitchen appliance from said user profile information, determines whether said age corresponds to said authorized ages as stored in said kitchen appliance characteristic information and authorizes use of said kitchen appliance as a function of such determination.

10. The kitchen appliance of claim 1, wherein said computer includes a real-time clock, said computer time stamping the access of said kitchen appliance by said user and storing said time stamp in said kitchen appliance characteristic information file associated with said kitchen appliance and said user profile information.

11. The kitchen appliance of claim 1, wherein said computer includes a time clock, said computer tracking the time said kitchen appliance is operated by an authorized user and storing said time of use in said user profile information and in said kitchen appliance characteristic file associated with said kitchen appliance.

12. The kitchen appliance of claim 1, wherein said computer, database and biometric input device are integrally formed with said kitchen appliance.

13. The kitchen appliance of claim 1, wherein said computer remotely controls operation of said kitchen appliance.

14. A system for operating a kitchen appliance comprising:
a first kitchen appliance, said first kitchen appliance including a first biometric input device for capturing a biometric characteristic;
a second kitchen appliance, having a second biometric input device for capturing one of said biometric characteristic or a second biometric characteristic, a database, containing user profile information including at least a biometric identity data corresponding to said biometric characteristic and said second biometric characteristic; and
a computer operatively coupled to said first kitchen appliance and first biometric input device, and said database for controlling operation of said first kitchen appliance in response to said biometric characteristic, and as a function of said user profile information; and said computer being operatively coupled to said second kitchen appliance and second biometric input device for controlling operation of said second kitchen appliance in response to said biometric characteristic or said second biometric characteristic and as a function of said user profile information.

15. The system of claim 14, wherein said user profile information further comprises operating mode data for said kitchen appliance, said operating instructions corresponding to authorized uses of at least one of said first and second kitchen appliances by a user corresponding to said biometric identity data.

16. The system of claim 15, wherein said operating mode data includes instructions for operating at least one of said first and second kitchen appliances in a language corresponding to the user identified by the biometric identity data.

17. The system of claim 15 further comprising kitchen appliance characteristic files stored in said database, said kitchen appliance characteristic files including operating parameters for each respective kitchen appliance.

18. The system of claim 17, wherein said kitchen appliance characteristic data includes an authorized age for potential users of each said respective kitchen appliance.

19. The system of claim 18, wherein said computer determines the age of a user of said kitchen appliance from said user profile information, determines whether said age corresponds to said authorized ages as stored in said kitchen appliance characteristic information and authorizes use of said kitchen appliance as a function of such determination.

20. The system of claim 15, wherein said computer includes a real time clock, said computer time stamping the access of a respective kitchen appliance by said user and storing said time stamp in at least one of said kitchen appliance characteristic information file associated with said kitchen appliance and said user profile information.

21. The system of claim 15, wherein said computer includes a time clock, said computer tracking the times that a respective one of said kitchen appliances operated by an authorized user and storing said time of use in at least one of said user profile information and in said kitchen appliance characteristic file associated with said kitchen appliance.

22. The system of claim 15, wherein said first biometric input device is integrally formed with said first kitchen appliance.

23. The system of claim 15, wherein said computer is integrally formed with at least one of said first kitchen appliance and said at least second kitchen appliance.

24. A method for operating a kitchen appliance including the steps of:
capturing a biometric characteristic at said kitchen appliance;
comparing said biometric characteristic with biometric characteristics of known users of said kitchen appliance; and
controlling operation of said kitchen appliance in response to said biometric characteristic and as a function of known user profile information associated with known users.

25. The method of claim 24, wherein said user profile information includes operating mode data for said kitchen appliance, said operating mode data corresponding to authorized uses of said kitchen appliance by a user corresponding to said biometric identity data.

26. The method of claim 25, wherein said operating mode data includes instructions for operating the kitchen appliance in a language corresponding to the user identified by the biometric data information.

27. The method of claim 25, further comprising the step of storing kitchen appliance characteristic information including operating parameters for said kitchen appliance.

28. The method of claim 27, wherein said kitchen appliance characteristic data includes an authorized age for potential users of said appliance.

29. The method of claim 28, further comprising the step of determining the user of said kitchen appliance from said user profile information, determining whether said age of said user corresponds to said authorized ages for said kitchen appliance, and authorizing use of said kitchen appliance as a function of such determination.

30. The method of claim 24, further comprising the steps of measuring the use time that a user operates a specific appliance, as an elapsed time and storing said time as user profile information and kitchen appliance characteristic information.

31. The method of claim 30, further comprising the steps of accumulating the elapsed time stored in said user profile information and determining an elapsed time value.
